(19) United States
(12) Patent Application Publication
(10) Pub. No.: US 2023/0229055 A1
(43) Pub. Date: Jul. 20, 2023

(54) ELECTRONIC PAPER DISPLAY DEVICE

(71) Applicant: E Ink Holdings Inc., HSINCHU (TW)

(72) Inventors: Yi-Sheng LIN, HSINCHU (TW); Chia-Chun YEH, HSINCHU (TW); Chen-Chu TSAI, HSINCHU (TW)

(21) Appl. No.: 18/048,864

(22) Filed: Oct. 24, 2022

(30) Foreign Application Priority Data
Jan. 4, 2022 (TW) 111100194

(51) Int. Cl. G02F 1/16753; G02F 1/167; G02F 1/1676; G02F 1/16757

(52) U.S. Cl. CPC G02F 1/16753; G02F 1/167; G02F 1/1676; G02F 1/16757; G02F 1/133305

(57) ABSTRACT

An electronic paper display device includes an upper supporting layer, a lower supporting layer, and an electronic ink layer. The lower supporting layer is opposite to the upper supporting layer. At least one of the upper supporting layer and the lower supporting layer has a thickness in a range from 1 μm to 50 μm and has a storage modulus in a range from 1 kPa to 100 kPa in 0° C. to 70° C. The electronic ink layer is located between the upper supporting layer and the lower supporting layer.

### RELATED APPLICATIONS

This application claims priority to Taiwan Application Serial Number 111100194, filed Jan. 4, 2022, which is herein incorporated by reference.

### BACKGROUND

### Field of Invention

The present disclosure relates to an electronic paper display device.

### Description of Related Art

In current market of various consumer electronic products, flexible display panels have been widely used as display screens for electronic products, such as electronic paper. The electronic ink layer of the flexible display panel is mainly composed of electrophoretic liquid and colored particles mixed in the electrophoretic liquid. By applying a voltage to the electronic ink layer, the colored particles can be driven to move, so that each pixel area displays black, white, grayscale or color. Since the flexible display panel utilizes incident light (such as sunlight, indoor ambient light, or front light module) to irradiate the electronic ink layer and reflect it to achieve the objective of display, a backlight is not required and power saving is achieved.

However, in a traditional flexible display panel, the electronic ink layer will bear a very large shear force in the bending state because the electronic ink layer is a very soft material as compared with the film materials (such as plastic or thin glass) on the upper and lower sides of the electronic ink layer. Because the above-mentioned film materials are not specially designed, during the process of repeated bending, the electronic ink layer will be damaged by the shear force at the edge of the bending area due to fatigue effect and fail.

### SUMMARY

One aspect of the present disclosure provides an electronic paper display device.

Some embodiments of the present disclosure provide an electronic paper display device. The electronic paper display device includes an upper supporting layer, a lower supporting layer, and an electronic ink layer. The lower supporting layer is opposite to the upper supporting layer. At least one of the upper supporting layer and the lower supporting layer has a thickness in a range from 1 μm to 50 μm and has a storage modulus in a range from 1 kPa to 100 kPa in 0° C. to 70° C. The electronic ink layer is located between the upper supporting layer and the lower supporting layer.

In the foregoing, at least one of the upper supporting layer and the lower supporting layer has the storage modulus in a range from 50 kPa to 300 kPa in −25° C. to 0° C.

In the foregoing, the lower supporting layer has a storage modulus in a range from 9 MPa to 11 MPa in 0° C. to 70° C.

In the foregoing, the upper supporting layer is an electrode layer.

In the foregoing, the lower supporting layer is a thin film transistor layer.

In the foregoing, the electronic ink layer includes a microcapsule or a microcup.

In the foregoing, the microcapsule or the microcup includes a plurality of black particles and a plurality of white particles therein.

In the foregoing, the microcapsule or the microcup contacts the upper supporting layer.

In the foregoing, the microcapsule or the microcup contacts the lower supporting layer.

In the foregoing, a storage modulus of the upper supporting layer is smaller than a storage modulus of the lower supporting layer.

In the foregoing, the upper supporting layer is an optically clear adhesive or a pressure sensitive adhesive.

In the foregoing, the lower supporting layer is an optically clear adhesive or a pressure sensitive adhesive.

Another aspect of the present disclosure provides an electronic paper display device.

Some embodiments of the present disclosure provide an electronic paper display device. The electronic paper display device includes an optical clear resin and a plurality of microcapsules. The microcapsules are located in the optical clear resin and surrounded by the optical clear resin. The optical clear resin has a thickness in a range from 20 μm to 100 μm and has a storage modulus in a range from 1 kPa to 100 kPa in 0° C. to 70° C.

In the foregoing, the storage modulus of the optical clear resin is in a range from 50 kPa to 300 kPa in −25° C. to 0° C.

In the foregoing, the optical clear resin is a UV-curable adhesive.

In the foregoing, the electronic paper display device further includes a thin film transistor layer. The optical clear resin surrounding the microcapsules is coated on the thin film transistor layer.

According to the above embodiments of the present disclosure, since the storage modulus of at least one of the upper supporting layer and the lower supporting layer on the upper and lower sides of the electronic ink layer or the storage modulus of the optical clear resin surrounding the microcapsules is in the range of 1 kPa to 100 kPa in 0° C. to 70° C., the very soft adhesive material can bear more shear force instead of the microcapsule(s) in the electronic ink layer when the electronic ink layer is bent, so that the microcapsule(s) bears a smaller shear strain to avoid failure of the microcapsule(s) due to fatigue. That is to say, one of the upper supporting layer and the lower supporting layer having the low storage modulus or the optical clear resin having the low storage modulus can reduce the shear force borne by the electronic ink layer during the bending process to effectively reduce the system stress, which can increase the bending times of the electronic ink layer to achieve a smaller bend radius of curvature. As a result, the service life of the electronic paper display device is extended.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts a cross-sectional view of an electronic paper display device according to one embodiment of the present disclosure;

FIG. 2 depicts a position-strain relationship chart of the electronic paper display device in FIG. 1 when it is bent;

FIG. 3 depicts a cross-sectional view of an electronic paper display device according to another embodiment of the present disclosure;

FIG. 4 depicts a position-strain relationship chart of the electronic paper display device in FIG. 3 when it is bent;

FIG. 5 depicts a cross-sectional view of an electronic paper display device according to still another embodiment of the present disclosure;

FIG. 6 depicts a cross-sectional view of an electronic paper display device according to yet another embodiment of the present disclosure;

FIG. 7 depicts a cross-sectional view of an electronic paper display device according to one embodiment of the present disclosure;

FIG. 8 depicts a cross-sectional view of an electronic paper display device according to another embodiment of the present disclosure;

FIG. 9 depicts a cross-sectional view of an electronic paper display device according to still another embodiment of the present disclosure; and

FIG. 10 depicts a cross-sectional view of an electronic paper display device according to yet another embodiment of the present disclosure.

### DESCRIPTION OF THE EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one component or feature's relationship to another component(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

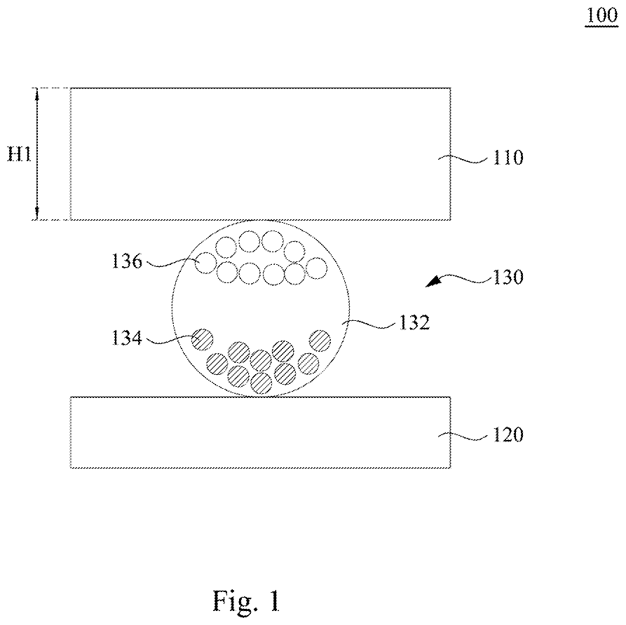

FIG. 1 depicts a cross-sectional view of an electronic paper display device 100 according to one embodiment of the present disclosure. The electronic paper display device 100 includes an upper supporting layer 110, a lower supporting layer 120, and an electronic ink layer 130. The upper supporting layer 110 or the lower supporting layer 120 may be adhered to the electronic ink layer 130, that is, the upper supporting layer 110 or the lower supporting layer 120 is an adhesive material layer. The above adhesive material layer is, for example, an optically clear adhesive (OCA) or a pressure sensitive adhesive (PSA), etc., and it has the characteristic of being bendable. The lower supporting layer 120 is opposite to the upper supporting layer 110. The electronic ink layer 130 is located between the upper supporting layer 110 and the lower supporting layer 120. In addition, the electronic ink layer 130 includes a microcapsule 132, and the upper supporting layer 110 and the lower supporting layer 120 can respectively limit upper and lower sides of the microcapsule 132 to define an area of the electronic ink layer 130. At least one of the upper supporting layer 110 and the lower supporting layer 120 has a thickness in a range from 1 μm to 50 μm and has a storage modulus (G′) in a range from 1 kPa to 100 kPa in 0° C. to 70° C. In the present embodiment, the upper supporting layer 110 has a thickness H1 in the range from 1 μm to 50 μm and a storage modulus in the range from 1 kPa to 100 kPa in 0° C. to 70° C., and a storage modulus of the lower supporting layer 120 is in a range from 9 MPa to 11 MPa in 0° C. to 70° C., for example, 10 MPa. The storage modulus of the upper supporting layer 110 is smaller than that of the lower supporting layer 120.

In greater detail, because at least one of the upper supporting layer 110 and the lower supporting layer 120 located on upper and lower sides of the electronic ink layer 130 has the storage modulus that is in the range from 1 kPa to 100 kPa in 0° C. to 70° C., a very soft adhesive material can bear more shear force instead of the microcapsule 132 in the electronic ink layer 130 when the electronic ink layer 130 is bent, so as to avoid failure of the microcapsule 132 due to fatigue. That is to say, one of the upper supporting layer 110 and the lower supporting layer 120 having the low storage modulus can reduce the shear force borne by the electronic ink layer 130 during the bending process to effectively reduce the system stress, thus increasing the bending times of the electronic ink layer 130 to achieve a smaller bend radius of curvature. As a result, the service life of the electronic paper display device 100 can be extended.

Additionally, in the present embodiment, the storage modulus of the upper supporting layer 110 is in a range from 50 kPa to 300 kPa in −25° C. to 0° C. The microcapsule 132 includes a plurality of black particles 134 and a plurality of white particles 136 therein. The microcapsule 132 may include particles of other colors. The present disclosure only takes the black particles and the white particles for example. The white particles 136 can reflect light to allow the electronic paper display device 100 to be in a bright state. The black particles 134 can absorb light to allow the electronic paper display device 100 to be in a dark state. The upper side and the lower side of the microcapsule 132 may contact the upper supporting layer 110 and the lower supporting layer 120, respectively, but the present disclosure is not limited in this regard.

In the above embodiment, the electronic ink layer 130 is first formed on a temporary substrate, and then the upper supporting layer 110 is utilized to be directly adhered to one side of the electronic ink layer 130, and finally the lower supporting layer 120 is directly adhered to another side of the electronic ink layer 130. The above completed electronic paper display device 100 is placed between a lower substrate having thin film transistors (TFTs) and an upper substrate having indium tin oxide (ITO) to complete an electronic paper display panel.

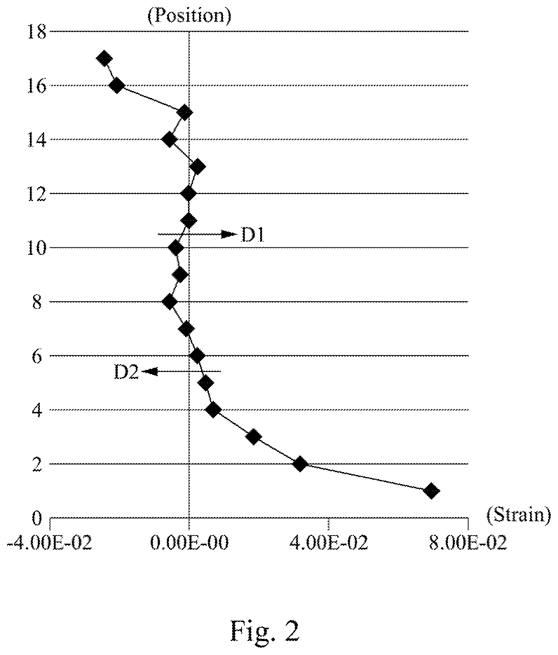

FIG. 2 depicts a position-strain relationship chart of the electronic paper display device 100 in FIG. 1 when it is bent. In FIG. 2, the vertical axis represents a position of the stack, and the horizontal axis represents the strain. A description is provided with reference to FIG. 1 and FIG. 2, an electrode layer (ITO layer), a touch layer, a front light module, and an upper protective layer may further be disposed above the upper support layer 110 of the electronic paper display device 100 in sequence. A thin film transistor (TFT) layer and a lower protective layer may further be disposed below the lower supporting layer 120 in sequence. When the electronic paper display device 100 is bent, since the storage modulus of the upper supporting layer 110 on the upper side of the electronic ink layer 130 is in the range of 1 kPa to 100 kPa in 0° C. to 70° C., only the outermost upper protective layer is compressed, the outermost lower protective layer is tensioned, and strains of remaining functional layers close to a center area (including the front light module, the touch layer, the electrode layer, the electronic ink layer 130, and the thin film transistor layer) can be effectively reduced during bending, such as the strains modified in a direction D1 and a direction D2 as shown in FIG. 2. The upper supporting layer 110 can bear more shear force instead of the microcapsule 132 in the electronic ink layer 130, so that the microcapsule 132 bears a smaller shear strain to avoid failure of the microcapsule 132 due to fatigue.

It should be understood that a description of the connection relationships, materials, and functions of the components that have already been described is not repeated, that must be explained first. In the following description, other types of electronic paper display devices are described.

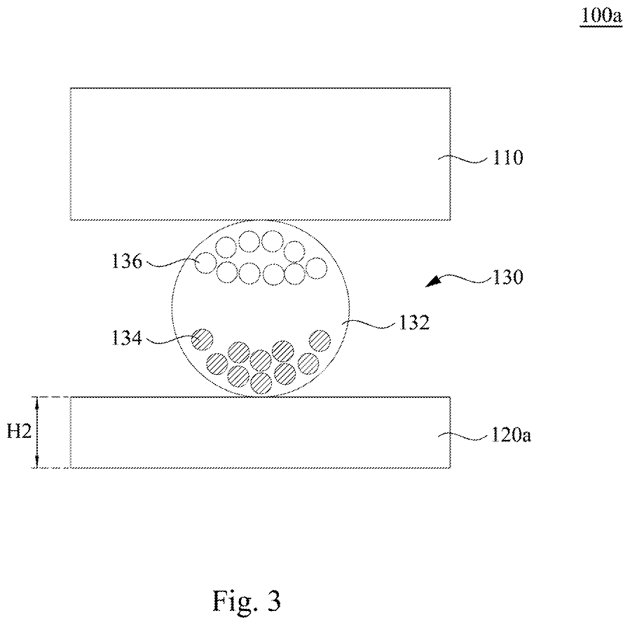

FIG. 3 depicts a cross-sectional view of an electronic paper display device 100a according to another embodiment of the present disclosure. The electronic paper display device 100a includes the upper supporting layer 110, a lower supporting layer 120a, and the electronic ink layer 130. Different from the embodiment in FIG. 1, a thickness H2 of the lower supporting layer 120a is in a range from 1 μm to 50 μm and a storage modulus of the lower supporting layer 120a is in the range of 1 kPa to 100 kPa in 0° C. to 70° C. That is, both the upper supporting layer 110 and the lower supporting layer 120a have the low storage moduli. In addition to that, the storage modulus of the lower supporting layer 120a is in the range from 50 kPa to 300 kPa in −25° C. to 0° C. Through the above design, the shear force borne by the electronic ink layer 130 during the bending process can be further reduced to effectively reduce the system stress, thus increasing the bending times of the electronic ink layer 130 to achieve a smaller bend radius of curvature.

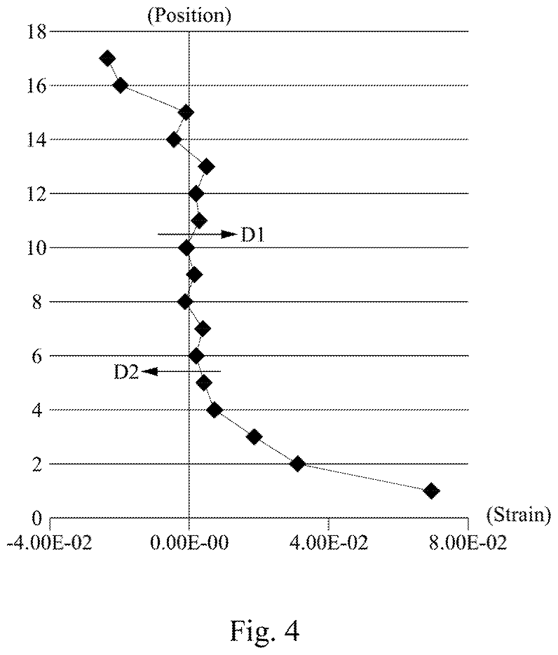

FIG. 4 depicts a position-strain relationship chart of the electronic paper display device 100a in FIG. 3 when it is bent. In FIG. 4, the vertical axis represents a position of the stack, and the horizontal axis represents the strain. A description is provided with reference to FIG. 3 and FIG. 4. When the electronic paper display device 100a is bent, since the storage moduli of the upper supporting layer 110 located on the upper side of the electronic ink layer 130 and the lower supporting layer 120a located on the lower side of the electronic ink layer 130 are both in the range of 1 kPa to 100 kPa in 0° C. to 70° C., the strains of functional layers close to the center area can be further reduced during bending when compared with FIG. 2, such as the strains modified in the direction D1 and the direction D2 as shown in FIG. 4. The upper supporting layer 110 and the lower supporting layer 120a can bear more shear force instead of the microcapsule 132 in the electronic ink layer 130, so that the microcapsule 132 bears a smaller shear strain to avoid failure of the microcapsule 132 due to fatigue.

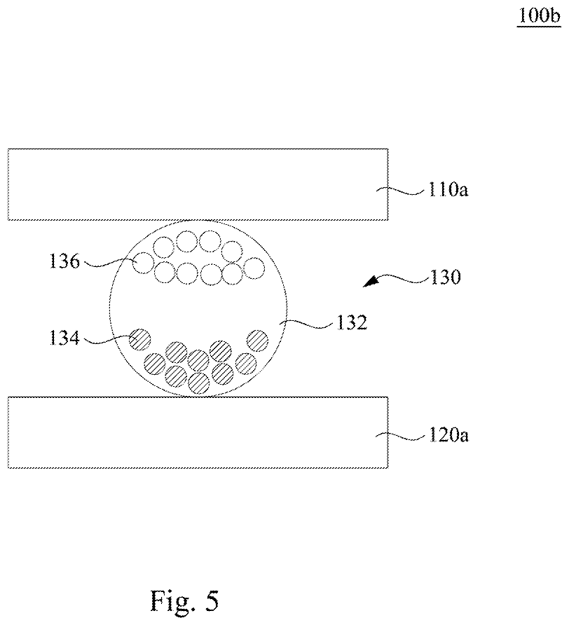

FIG. 5 depicts a cross-sectional view of an electronic paper display device 100b according to still another embodiment of the present disclosure. The electronic paper display device 100b includes an upper supporting layer 110a, the lower supporting layer 120a, and the electronic ink layer 130. Different from the embodiment in FIG. 3, the upper supporting layer 110a is an electrode layer, such as ITO PET (polyethylene terephthalate). That is, ITO is directly fabricated on a PET surface of the upper supporting layer, the electrode layer and the upper supporting layer are integrated into the same layer, and the electronic ink layer 130 having the microcapsule 132 is fabricated on a bottom surface of the electrode layer, and then the lower supporting layer 120a is adhered to a surface of the electronic ink layer 130. The lower supporting layer 120a adopts an adhesive material having a low storage modulus, for example, the storage modulus is in the range from 1 kPa to 100 kPa in 0° C. to 70° C.

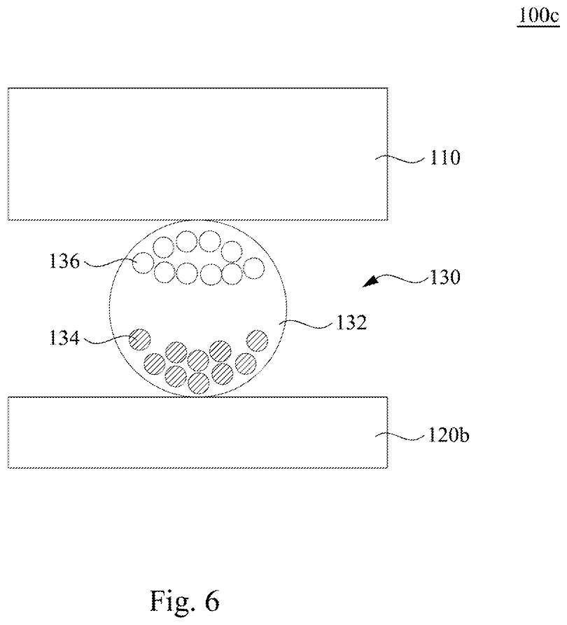

FIG. 6 depicts a cross-sectional view of an electronic paper display device 100c according to another embodiment of the present disclosure. The electronic paper display device 100c includes the upper supporting layer 110, a lower supporting layer 120b, and the electronic ink layer 130. Different from the embodiment in FIG. 1, the lower supporting layer 120b is a thin film transistor layer. For example, thin film transistors are directly fabricated on a surface of the lower supporting layer 120b, and the electronic ink layer 130 having the microcapsule 132 is fabricated on a drive circuit, and then the upper supporting layer 110 is adhered to a surface of the electronic ink layer 130. The upper supporting layer 110 adopts an adhesive material having a low storage modulus, for example, the storage modulus is in the range from 1 kPa to 100 kPa in 0° C. to 70° C.

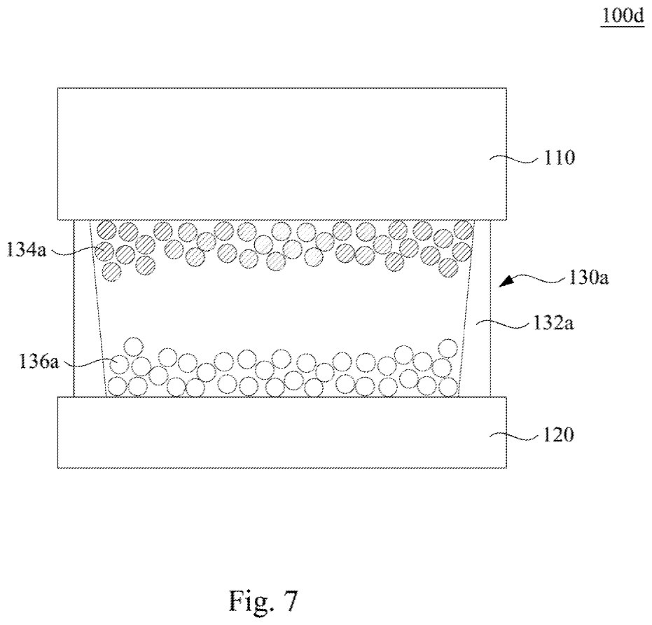

FIG. 7 depicts a cross-sectional view of an electronic paper display device 100d according to one embodiment of the present disclosure. The electronic paper display device 100d includes the upper supporting layer 110, the lower supporting layer 120, and an electronic ink layer 130a. Different from the embodiment in FIG. 1, the electronic ink layer 130a includes a microcup 132a, and the microcup 132a includes a plurality of black particles 134a and a plurality of white particles 136a therein. In the present embodiment, the microcup 132a can contact the upper supporting layer 110 and the lower supporting layer 120, but the present disclosure is not limited in this regard. The upper supporting layer 110 adopts an adhesive material having a low storage modulus, for example, the storage modulus is in the range from 1 kPa to 100 kPa in 0° C. to 70° C.

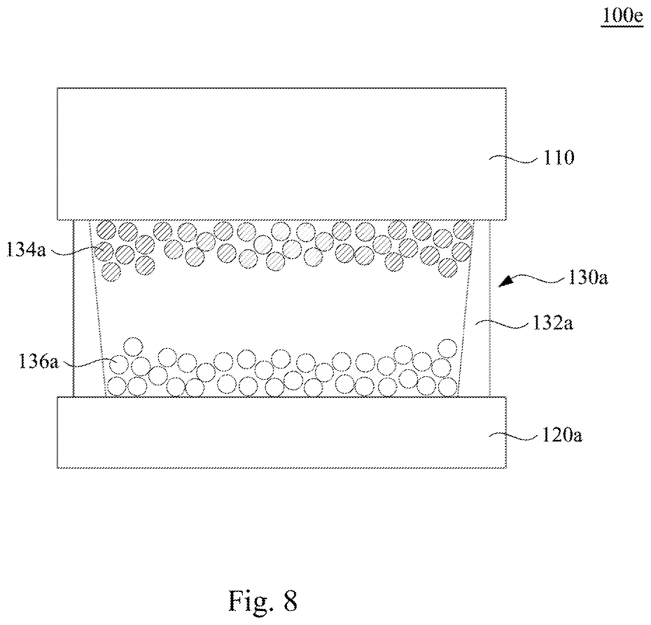

FIG. 8 depicts a cross-sectional view of an electronic paper display device 100e according to another embodiment of the present disclosure. The electronic paper display device 100e includes the upper supporting layer 110, the lower supporting layer 120a, and the electronic ink layer 130a. Different from the embodiment in FIG. 7, the storage modulus of the lower supporting layer 120a is in the range of 1 kPa to 100 kPa in 0° C. to 70° C. That is, both the upper supporting layer 110 and the lower supporting layer 120a have the low storage moduli.

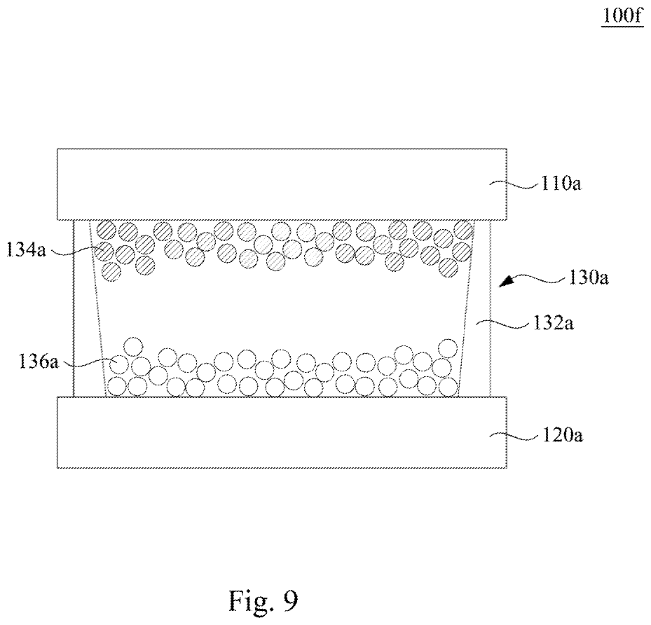

FIG. 9 depicts a cross-sectional view of an electronic paper display device 100f according to still another embodiment of the present disclosure. The electronic paper display device 100f includes the upper supporting layer 110a, the lower supporting layer 120a, and the electronic ink layer 130a. Different from the embodiment in FIG. 8, the upper supporting layer 110a is an electrode layer (such as ITO PET), and the electronic ink layer 130a having the microcup 132a is fabricated on a bottom surface of the electrode layer. The lower supporting layer 120a adopts an adhesive material having a low storage modulus, for example, the storage modulus is in the range from 1 kPa to 100 kPa in 0° C. to 70° C.

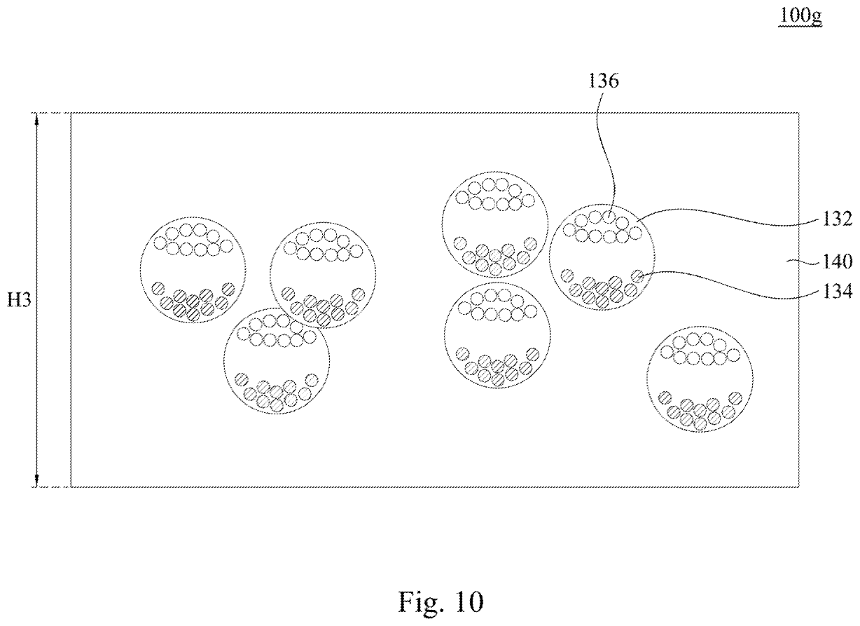

FIG. 10 depicts a cross-sectional view of an electronic paper display device 100g according to yet another embodiment of the present disclosure. The electronic paper display device 100g includes an optical clear resin (OCR) 140 and a plurality of microcapsules 132. The microcapsules 132 are located in and surrounded by the optical clear resin 140. The optical clear resin 140 has a thickness H3 in a range from 20 μm to 100 μm and has a storage modulus in the range from 1 kPa to 100 kPa in 0° C. to 70° C. In addition, the storage modulus of the optical clear resin 140 is in the range from 50 kPa to 300 kPa in −25° C. to 0° C. In the present embodiment, the optical clear resin 140 may be an ultraviolet-curable (UV-curable) adhesive.

The microcapsules 132 can be mixed into the optical clear resin 140 after being sifted by particle size, and then stirred and dispersed. Next, a coating process can be utilized to coat the optical clear resin 140 on a drive circuit, for example, coat the optical clear resin 140 on the lower supporting layer 120b in FIG. 6 (the lower supporting layer 120b is the thin film transistor layer), and ultraviolet (UV) light is used to cure the optical clear resin 140.

The optical clear resin 140 containing the microcapsules 132 can serve as an electronic ink layer. Since the optical clear resin 140 surrounding the microcapsules 132 has the storage modulus in the range of 1 kPa to 100 kPa in 0° C. to 70° C., the optical clear resin 140 can bear more shear force instead of the microcapsules 132 when being bent, so that the microcapsules 132 bear a smaller shear strain to avoid failure of the microcapsules 132 due to fatigue.

The foregoing has described features of several embodiments to allow those skilled in the art to better understand aspects of the present disclosure. Those skilled in the art should appreciate that they may readily use the present disclosure as a basis for designing or modifying other processes and structures to achieve the same objectives and/or achieve the same advantages of the embodiments described herein. Those skilled in the art should also understand that such equivalent structures do not depart from the spirit and scope of the present disclosure, and various changes, substitutions and alterations can be made herein without departing from the spirit and scope of the present disclosure.

What is claimed is:

1. An electronic paper display device comprising:
an upper supporting layer;
a lower supporting layer opposite to the upper supporting layer, wherein at least one of the upper supporting layer and the lower supporting layer has a thickness in a range from 1 μm to 50 μm and has a storage modulus in a range from 1 kPa to 100 kPa in 0° C. to 70° C.; and
an electronic ink layer located between the upper supporting layer and the lower supporting layer.

2. The electronic paper display device of claim 1, wherein at least one of the upper supporting layer and the lower supporting layer has the storage modulus in a range from 50 kPa to 300 kPa in −25° C. to 0° C.

3. The electronic paper display device of claim 1, wherein the lower supporting layer has a storage modulus in a range from 9 MPa to 11 MPa in 0° C. to 70° C.

4. The electronic paper display device of claim 1, wherein the upper supporting layer is an electrode layer.

5. The electronic paper display device of claim 1, wherein the lower supporting layer is a thin film transistor layer.

6. The electronic paper display device of claim 1, wherein the electronic ink layer comprises a microcapsule or a microcup.

7. The electronic paper display device of claim 6, wherein the microcapsule or the microcup contacts the upper supporting layer.

8. The electronic paper display device of claim 6, wherein the microcapsule or the microcup contacts the lower supporting layer.

9. The electronic paper display device of claim 1, wherein a storage modulus of the upper supporting layer is smaller than a storage modulus of the lower supporting layer.

10. The electronic paper display device of claim 1, wherein the upper supporting layer is an optically clear adhesive or a pressure sensitive adhesive.

11. The electronic paper display device of claim 1, wherein the lower supporting layer is an optically clear adhesive or a pressure sensitive adhesive.

12. An electronic paper display device comprising:
an optical clear resin; and
a plurality of microcapsules located in the optical clear resin and surrounded by the optical clear resin, wherein the optical clear resin has a thickness in a range from 20 μm to 100 μm and has a storage modulus in a range from 1 kPa to 100 kPa in 0° C. to 70° C.

13. The electronic paper display device of claim 12, wherein the storage modulus of the optical clear resin is in a range from 50 kPa to 300 kPa in −25° C. to 0° C.

14. The electronic paper display device of claim 12, wherein the optical clear resin is a UV-curable adhesive.

15. The electronic paper display device of claim 12, further comprising:
a thin film transistor layer, wherein the optical clear resin surrounding the microcapsules is coated on the thin film transistor layer.
